(19) United States
(12) Patent Application Publication
(10) Pub. No.: US 2019/0248500 A1
(43) Pub. Date: Aug. 15, 2019

(54) REDUCED-WIRING CONTROLLER FOR AIRCRAFT USE

(71) Applicant: Goodrich Corporation, Charlotte, NC (US)

(72) Inventors: Carl Aeschliman, Rittman, OH (US); John A. Harr, Minerva, OH (US)

(21) Appl. No.: 16/270,813

(22) Filed: Feb. 8, 2019

Related U.S. Application Data
(60) Provisional application No. 62/628,523, filed on Feb. 9, 2018.

(51) Int. Cl. B64D 13/08; H04Q 9/02; B64D 13/06

(52) U.S. Cl. CPC B64D 13/08; B64D 2013/0603; B64D 13/06; H04Q 9/02

(57) ABSTRACT

A distributed controller of an aircraft includes a first communication device, a second communication device, and at least one processor. The first communication device is configured to transmit heater status data and receive heater command data via radio waves or power-line communication. The second communication device is configured to transmit at least one heater control signal and to receive heater sensor data. The at least one processor is configured to provide heater control based upon the heater command data and the heater sensor data and to provide heater status information based upon the received heater sensor data.

### CROSS-REFERENCE TO RELATED APPLICATION(S)

This application claims the benefit of U.S. Provisional Application No. 62/628,523 filed Feb. 9, 2018 for “REDUCED-WIRING CONTROLLER FOR AIRCRAFT USE” by C. Aeschliman, and J. A. Harr.

### BACKGROUND

The current nature of temperature controllers and other types of component controllers onboard aircraft use dedicated control and communications wiring for providing component operational status and control information exchange. With the increasingly large number of component controllers on commercial aircraft, this results in considerable wiring complexity and wiring weight.

### SUMMARY

In one example, a distributed controller of an aircraft comprises a first communication device, a second communication device, at least one power controller device, and at least one processor. The first communication device is configured to transmit heater status data and receive heater command data via radio waves or power-line communication. The second communication device is configured to receive heater sensor data. The at least one power controller device is configured to provide heater control upon the heater command data and the heater sensor data. The at least one processor is configured to provide heater status information based upon the received heater sensor data.

A reduced-wiring distributed controller system of an aircraft comprises a data collector, a power bus, a heater system, and a distributed controller. The data collector is configured to transmit heater command data. The power bus is configured to provide power. The a heater system comprises a heater, one or more sensors, and a first communication device. The one or more sensors are configured to monitor the heater and provide heater sensor data. The first communication device is configured to transmit the heater sensor data. The at least one distributed controller is electrically coupled to the power bus. The at least one distributed controller is configured to provide control to the heater system and provide a status of the heater system to the data collector. The at least one distributed controller comprises a second communication device, a third communication device, at least one power controller device, and at least one processor. The second communication device is configured to transmit heater status data and receive heater command data via radio waves or power-line communication. The third communication device is configured to receive heater sensor data. The at least one power controller device is configured to provide heater control upon the heater command data and the heater sensor data. The at least one processor is configured to provide heater status information based upon the received heater sensor data.

In one example, a method for controlling a heating system of an aircraft comprises receiving a heater command signal from a data collector using a first communication device, the heater command signal received via radio waves or power-line communication; providing heater control using a heater controller device in response to receiving the heater command signal; receiving heater sensor data using the second communication device; and transmitting heater status data to the data collector using the first communication device in response to receiving the heater sensor data, the heater status data transmitted via radio waves or power-line communication.

### BRIEF DESCRIPTION OF THE DRAWINGS

FIG. 1 is a block diagram of a reduced-wiring distributed controller system.

FIG. 2 is a block diagram of a distributed controller and heater system of a reduced-wiring distributed controller system.

FIG. 3 is a flow diagram depicting a process for controlling a heating system using a distributed controller.

### DETAILED DESCRIPTION

Apparatus, systems, and associated methods relate to reduced-wiring distributed controller systems of aircraft. In some applications, such as heater system control, distributed controllers are used to reduce wiring and thereby reduce the weight and cost of aircraft. Distributed controllers transmit and receive data to/from a data collector using radio signals or information over power lines. Using the apparatus, systems, and associated methods herein, allows for bidirectional communication with a data collector without the extensive wiring of traditional apparatus, systems, and methods.

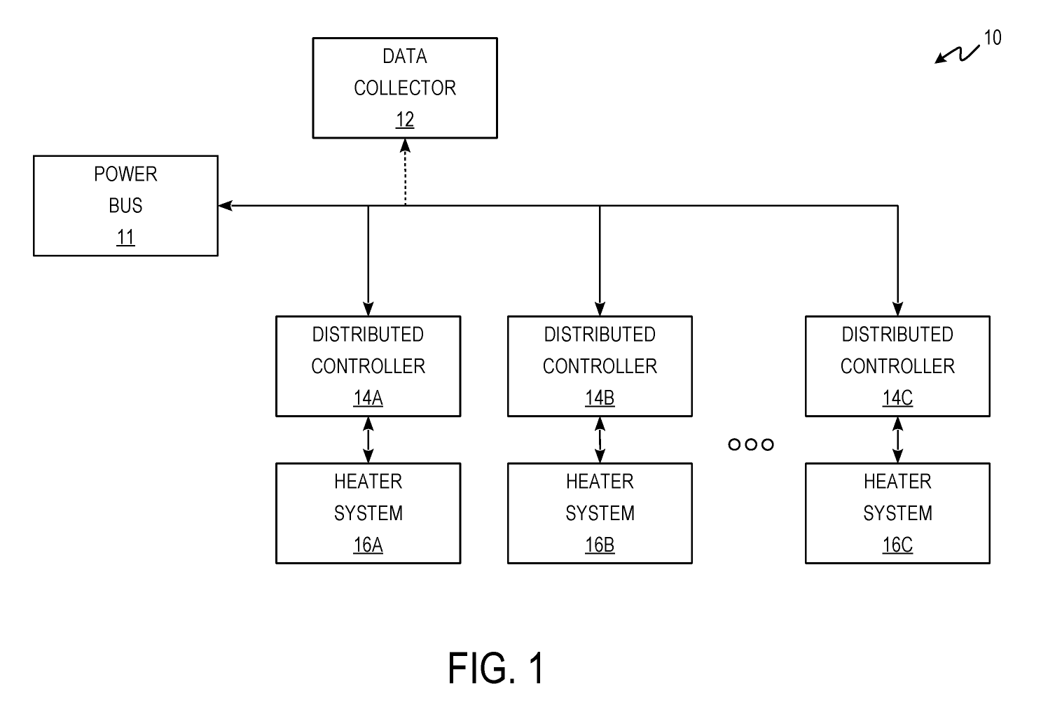

FIG. 1 is a block diagram of reduced-wiring distributed controller system 10 including power bus 11, data collector 12, distributed controllers 14A-14C, and heater systems 16A-16C.

Power bus 11 is configured to provide power to distributed controllers 14A-14C. Distributed controllers are configured to control heating systems 16A-16C respectively. Distributed controllers 14A-14C receive heater sensor data from heater systems 16A-16C including temperature, heater current, current state of the heater, set points, etc. Distributed controllers 14A-14C provide commands to heating systems 16A-16C including on/off commands, new set points, etc. Distributed controllers 14A-14C are configured to communicate with data collector 12 using wireless radio signals or power-line communication. When distributed controllers 14A-14C are configured to use power-line communication, data collector 12 is electrically coupled to power bus 11 (as shown by dotted line in FIG. 1). When distributed controllers 14A-14C are configured to use wireless radio signals, data collector 12 may or may not be electrically coupled to power bus 11. In some examples, distributed controllers can be used for controlling/monitoring electro-mechanical multi-position valves in the potable water system and waste system, supplemental HVAC, lighting and other systems.

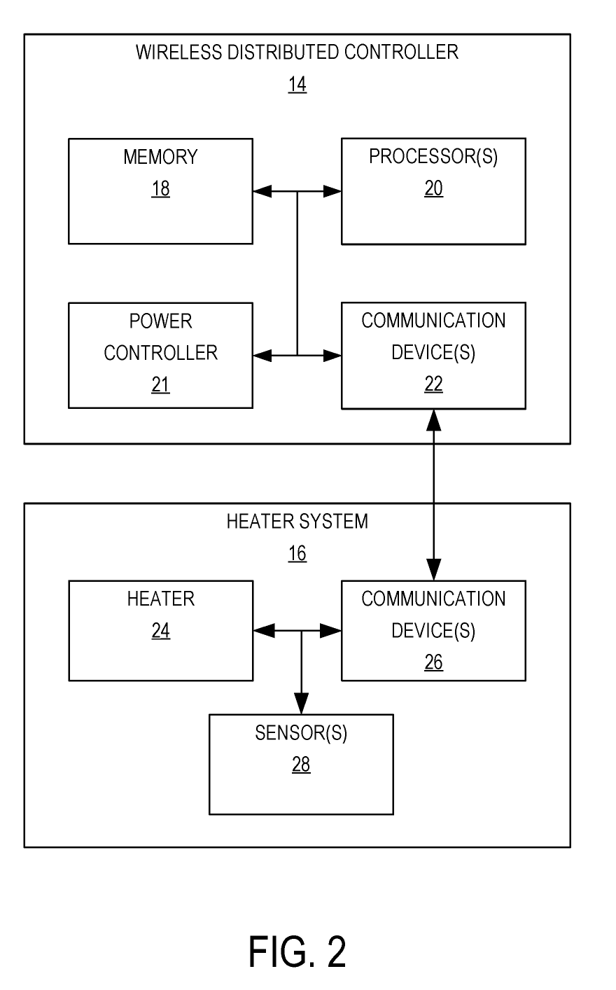

FIG. 2 is a block diagram of distributed controller 14 (which may be any of distributed controllers 14A-14C shown in FIG. 1) and heater system 16 (which may be any corresponding one of distributed controllers 16A-16C shown in FIG. 1) of a reduced-wiring distributed controller system. Distributed controller 14 includes computer-readable memory 18, one or more processors 20, heater controller device 21, first communication device(s) 22a and second communication device(s) 22b. Heater system 16 includes heater 24, communication device(s) 26, and one or more sensors 28.

Communication device(s) 22a can include transmitters, receivers, transceivers designed to communicate with wireless signals, and/or power-line communication signals, for example, for communicating to data collectors, such as data collector 12 (FIG. 1). Communication device(s) 22b can include wired signals and/or wireless signals, for example, for communicating to heater system 16.

Computer-readable memory 18 can be configured to store information within distributed controller during operation. Computer-readable memory 18, in some examples, is described as a computer-readable storage medium. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, computer-readable memory 18 is a temporary memory, meaning that a primary purpose of computer-readable memory 18 is not long-term storage. Computer-readable memory 18, in some examples, is described as a volatile memory, meaning that Computer-readable memory 18 does not maintain stored contents when power to distributed controller 14 is removed. Examples of volatile memories can include random access memories (RAM), dynamic random access memories (DRAM), static random access memories (SRAM), and other forms of volatile memories. In some examples, computer-readable memory 18 is used to store program instructions for execution by processor(s) 20. Computer-readable memory 18, in certain examples, is used by software applications running on computing device 16 to temporarily store information during program execution, such as transmitting and receiving data using communication device(s) 22a and/or 22b, determining the status of heater system 16 based upon received heater sensor data, and providing control data based upon heater command data received.

Computer-readable memory 18, in some examples, also includes one or more computer-readable storage media. Computer-readable memory 18 can be configured to store larger amounts of information than volatile memory. Computer-readable memory 18 can further be configured for long-term storage of information. In some examples, computer-readable memory 18 may include non-volatile storage elements. Examples of non-volatile storage elements can include magnetic hard discs, optical discs, floppy discs, flash memories, or forms of electrically programmable memories (EPROM) or electrically erasable and programmable (EEPROM) memories. In one example, computer-readable memory 18 is configured to store data including the geometry of the tank holding the liquid.

Processor(s) 20, in one example, is configured to implement functionality and/or process instructions for execution within distributed controller 14. For instance, processor(s) 20 can be capable of processing instructions stored in memory of processor(s) 20. Examples of processor(s) 20 can include any one or more of a microprocessor, a controller, a digital signal processor (DSP), an application specific integrated circuit (ASIC), a field-programmable gate array (FPGA), or other equivalent discrete or integrated logic circuitry. Processor(s) 20 is configured to execute instructions to carry out tasks such as transmitting and receiving data using communication device(s) 22a and/or 22b, determining the status of heater system 16 based upon received heater sensor data, and providing control data based upon heater command data received.

Heater controller device 21 is configured to provide heater control to heater 24. Providing heater control can include switching an AC power supply, voltage conversion, turning power off, turning power on, etc. In one example, heater controller device 21 receives heater control data from processor(s) 22 and provides heater control based upon the heater control data. In one example, heater controller device 21 receives a heater control signal from communication device(s) 22 and provides heater control based upon the heater control signal.

Communication device(s) 26 of heater system 16 can include transmitters, receivers, or other transceivers designed to communicate with wired signals and/or wireless signals, for example, for communicating with communication device(s) 22b of controller 14.

Sensor(s) 28 are configured to sense parameters of heater 24 and provide heater sensor data. Sensor(s) 28 can include temperature sensors, current sensors, position sensors, or other sensors used to determine the health and status of a heating system. Sensor(s) 28 are configured to provide heater sensor data to communication device(s) 26 to be transmitted to distributed controller 14.

Heater 24 is configured to provide heat to a region of an aircraft. The region could be a supply hose, a valve, the cabin, a window, or other part of the aircraft. Heater 24 includes a heating element, a switch, a regulator, etc. Heater 24 receives heater control data from distributed controller 14 via communication device(s) 26. Heater 24 alters settings such as turning on/off and changing set points in response to received heater control data.

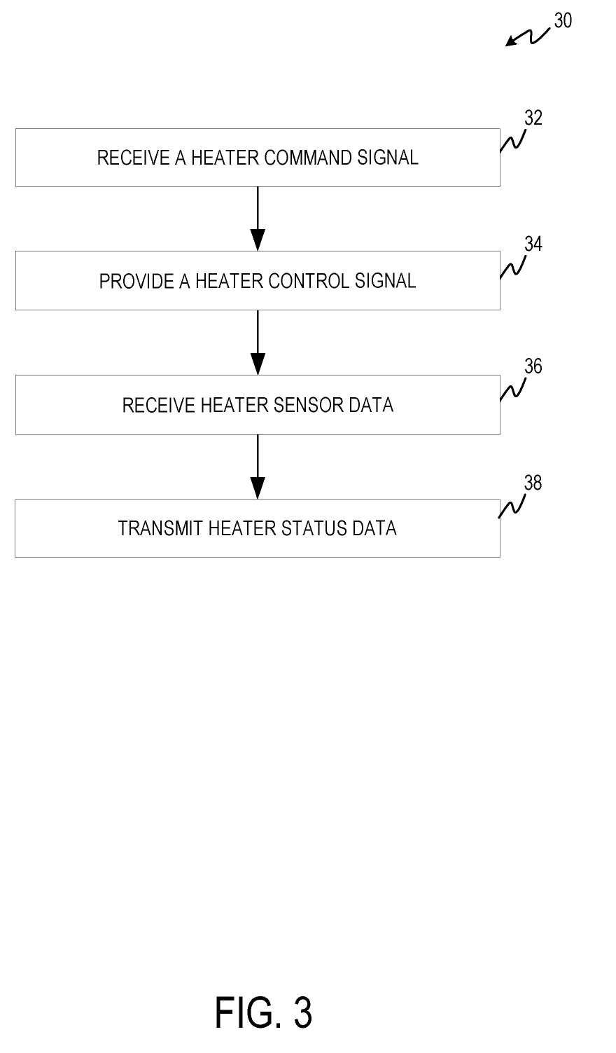

FIG. 3 is a flow diagram depicting process 30 for controlling a heating system using a distributed controller. For purposes of clarity and ease of discussion, the example heating system control is described below within the context of distributed controller 14 and heater system 16 of FIG. 2.

At step 32, a heater command signal is received from a data collection device. The heater command signal is received using a first communication device configured to communicate via wireless radio signals or power-line communication. At step 34, a heater control signal is transmitted to a heater system using a second communication device. The heater control signal is sent in response to receiving the command signal. At step 36, heater sensor data is received from the heater system using the second communication device. At step 38, heater status data is provided to the data collector using the first communication device, via wireless radio signals or power-line communication.

Accordingly, implementing techniques of this disclosure, distributed controllers allow bidirectional communication without dedicated control and communications wiring in the form of discrete signal lines or data communication busses. Distributed controllers communicate with data collectors using radio signals or power-line communication protocols. Using the distributed controllers as described herein, can allow for a reduction in wiring, thereby reducing the weight and cost of an aircraft.

### Discussion of Possible Embodiments

The following are non-exclusive descriptions of possible embodiments of the present invention.

A distributed controller of an aircraft comprising: a first communication device configured to transmit heater status data and receive heater command data via radio waves or power-line communication; a second communication device configured to receive heater sensor data; at least one power controller device configured to provide heater control upon the heater command data and the heater sensor data; and at least one processor configured to provide heater status information based upon the received heater sensor data.

The distributed controller of the preceding paragraph can optionally include, additionally and/or alternatively, any one or more of the following features, configurations and/or additional components:

The first communication device is a wireless transceiver and is configured to transmit the heater status data and receive the heater command data using radio waves.

The first communication device is a power-line communication transceiver and is configured to transmit the heater status data and receive the heater command data using power-line communication.

A reduced-wiring distributed controller system of an aircraft can comprise a data collector configured to transmit heater command data; a power bus configured to provide power; a heater system comprising: a heater; one or more sensors configured to monitor the heater and provide heater sensor data; and a first communication device configured to transmit the heater sensor data; and at least one distributed controller electrically coupled to the power bus, the at least one distributed controller configured to provide control to the heater system and provide a status of the heater system to the data collector, the at least one distributed controller comprising: a second communication device configured to transmit heater status data and receive heater command data via radio waves or power-line communication; a third communication device configured to transmit at least one heater control signal and to receive heater sensor data; and at least one power controller device configured to provide heater control upon the heater command data and the heater sensor data; and at least one processor configured to provide heater status information based upon the received heater sensor data.

The reduced-wiring distributed controller system of the preceding paragraph can optionally include, additionally and/or alternatively, any one or more of the following features, configurations and/or additional components:

The second communication device can be a wireless transceiver and is configured to transmit the heater status data and receive the heater command data using radio waves.

The second communication device can be a power-line communication transceiver and is configured to transmit the heater status data and receive the heater command data using power-line communication; and wherein the data collector is electrically coupled to the power bus.

A method for controlling a heating system of an aircraft can comprise receiving a heater command signal from a data collector using a first communication device, the heater command signal received via radio waves or power-line communication; providing heater control using a heater controller device in response to receiving the heater command signal; receiving heater sensor data using the second communication device; and transmitting heater status data to the data collector using the first communication device in response to receiving the heater sensor data, the heater status data transmitted via radio waves or power-line communication.

The method of the preceding paragraph can optionally include, additionally and/or alternatively, any one or more of the following features, configurations and/or additional components:

The first communication device can be a wireless transceiver and is configured to transmit the heater status data and receive the heater command data using radio waves.

The first communication device can be a power-line communication transceiver and is configured to transmit the heater status data and receive the heater command data using power-line communication.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A distributed controller of an aircraft comprising:
a first communication device configured to transmit heater status data and receive heater command data via radio waves or power-line communication;
a second communication device configured to receive heater sensor data;
at least one power controller device configured to provide heater control upon the heater command data and the heater sensor data; and
at least one processor configured to provide heater status information based upon the received heater sensor data.

2. The distributed controller of claim 1, wherein the first communication device is a wireless transceiver and is configured to transmit the heater status data and receive the heater command data using radio waves.

3. The distributed controller of claim 1, wherein the first communication device is a power-line communication transceiver and is configured to transmit the heater status data and receive the heater command data using power-line communication.

4. A reduced-wiring distributed controller system of an aircraft comprising:
a data collector configured to transmit heater command data;
a power bus configured to provide power;
a heater system comprising:
a heater;
one or more sensors configured to monitor the heater and provide heater sensor data; and
a first communication device configured to transmit the heater sensor data; and
at least one distributed controller electrically coupled to the power bus, the at least one distributed controller configured to provide control to the heater system and provide a status of the heater system to the data collector, the at least one distributed controller comprising:
a second communication device configured to transmit heater status data and receive heater command data via radio waves or power-line communication;
a third communication device configured to transmit at least one heater control signal and to receive heater sensor data; and
at least one power controller device configured to provide heater control upon the heater command data and the heater sensor data; and
at least one processor configured to provide heater status information based upon the received heater sensor data.

5. The system of claim 4, wherein the second communication device is a wireless transceiver and is configured to transmit the heater status data and receive the heater command data using radio waves.

6. The system of claim 4, wherein the second communication device is a power-line communication transceiver and is configured to transmit the heater status data and receive the heater command data using power-line communication; and
wherein the data collector is electrically coupled to the power bus.

7. A method for controlling a heating system of an aircraft comprising:
receiving a heater command signal from a data collector using a first communication device, the heater command signal received via radio waves or power-line communication;
providing heater control using a heater controller device in response to receiving the heater command signal;
receiving heater sensor data using the second communication device; and
transmitting heater status data to the data collector using the first communication device in response to receiving the heater sensor data, the heater status data transmitted via radio waves or power-line communication.

8. The method of claim 7, wherein the first communication device is a wireless transceiver and is configured to transmit the heater status data and receive the heater command data using radio waves.

9. The method of claim 7, wherein the first communication device is a power-line communication transceiver and is configured to transmit the heater status data and receive the heater command data using power-line communication.
